(19) United States
(12) Patent Application Publication
(10) Pub. No.: US 2019/0384076 A1
(43) Pub. Date: Dec. 19, 2019

(54) Phase Noise-Modulated Broadband Light Source Apparatus And Method

(71) Applicant: The Charles Stark Draper Laboratory, Inc., Cambridge, MA (US)

(72) Inventor: Gilbert D. Feke, Windham, NH (US)

(21) Appl. No.: 16/382,688

(22) Filed: Apr. 12, 2019

Related U.S. Application Data
(60) Provisional application No. 62/685,675, filed on Jun. 15, 2018.

(51) Int. Cl. G02F 1/035; G01C 19/72; G02B 6/27; F21V 8/00; G01B 9/02

(52) U.S. Cl. CPC G02F 1/035; G01C 19/723; G01B 9/02091; G02B 6/0006; G02B 6/272

(57) ABSTRACT

An apparatus, and corresponding method, includes a broadband light source configured to provide broadband source light and at least one optical phase modulator configured to receive the broadband source light and to deliver conditioned broadband output light having at least one of reduced spectral modulation depth and increased central degree of nth-order temporal coherence, characterized by a phase noise modulation enhancement factor, where n is an integer greater than or equal to 2, relative to the broadband source light.

### RELATED APPLICATION

This application claims the benefit of U.S. Provisional Application No. 62/685,675, filed on Jun. 15, 2018. The entire teachings of the above application are incorporated herein by reference.

### GOVERNMENT SUPPORT

This invention was made with government support under Contract # N00030-13-C-0007 from Department of Defense. The government has certain rights in the invention.

### TECHNICAL FIELD

This disclosure relates generally to light sources and more particularly to a phase noise-modulated broadband light source apparatus and method for delivering output light conditioned to have reduced spectral modulation depth, increased central degree of nth-order temporal coherence, whereby n is an integer greater than or equal to 2, or both.

### BACKGROUND

Broadband light sources, for example light sources with full width at half maximum (FWHM) bandwidth of about 5 nm or greater, are well known in the art and are used in a variety of applications. In particular, broadband light sources such as superluminescent diodes (SLDs), rare-earth-doped superluminescent sources (REDSLSs), light emitting diodes (LEDs), and supercontinuum fiber are useful in applications related to interferometry to avoid coherence noise effects.

For example, fiber optic gyroscopes (FOGs) use the interference of light to measure angular velocity as known in the art. Rotation is sensed in a FOG with a large coil of optical fiber forming a Sagnac interferometer as described for example in H. C. Lefèvre, The Fiber Optic Gyroscope, 2nd Edition, Boston: Artech House (2014). The induced phase shift between the counterpropagating light waves injected in the sensor coil is proportional to the rotation rate. The proportionality constant, called “scale factor”, is given by 2πLD/λ̅c, where L is the length of the fiber coil, D is the diameter of the fiber coil, c is the speed of light in vacuum, and λ̅ is the average, or centroid, wavelength of the light waves propagating in the coil.

Broadband light sources are particularly advantageous for introducing the light into the sensor coil because phase coherent noise effects due to backscattering noise and polarization coupling is suppressed, the residual intensity noise (RIN) of the FOG decreases with increasing bandwidth, and the zero-rotation drift induced through the Kerr effect by relative variations in the two counterpropagating optical powers is reduced. Such effects would otherwise cause significant reduction in rotation sensitivity and accuracy. The relatively small size, low power consumption and low cost of SLDs are advantageous for many FOG applications.

In addition to FOGs, other optical sensors and measuring devices as known in the art, such as accelerometers, pressure sensors, strain sensors, temperature sensors, profilometers, fiber optic link test equipment, optical coherence tomography systems, and ghost imaging systems provide applications for which broadband light sources enjoy utility.

In many such applications, conditioning of the output light from the broadband light source would be advantageous. For example, the unconditioned output light from SLDs typically suffers from spectral modulation, also known as gain ripple. For example, a standard commercially available SLD from Thorlabs, part number SLD1005S, is specified to have, typically, a 0.2 dB root-mean-square (RMS) spectral modulation depth for typical output power, and the spectral modulation depth specification increases further as the output power increases.

Furthermore, the unconditioned output light from SLDs can be modeled as a combination of deterministic light of fraction n_{det}, the deterministic light obeying Poissonian statistics and having g_{det}⁽²⁾(0)=1, and chaotic light of fraction n_{chao}, the chaotic light obeying Bose-Einstein statistics and having a central degree of second-order temporal coherence g_{chao}⁽²⁾(0)=½(3+DOP²) where DOP is degree of polarization, and, whereby n_{det}+n_{chao}=1. The mixing ratio r=n_{chao}/n_{det} is dependent on output power with n_{chao}>n_{det} for low output power and n_{det}>n_{chao} for high output power, and therefore the resulting combined g_{source}⁽²⁾(0) is also dependent on output power according to

$${g}_{source}^{( 2 )} ( 0 ) = 2 - {( \frac{1}{1 + r} )}^{2}$$

assuming polarized light such that

$$DOP = 1 and {g}_{chao}^{( 2 )} ( 0 ) = 2.$$

Typically the combined

$${g}_{source}^{( 2 )} ( 0 )$$

is in a range from 1.9 for low output power to 1.1 for high output power.

### SUMMARY

For SLDs and similar broadband light sources used in certain applications, the unconditioned spectral modulation may be relatively high and the unconditioned central degree of second-order temporal coherence may be relatively low, especially for high output power configurations that are often desirable to achieve high signal-to-noise ratio, and therefore these shortcomings limit the accuracy of optical sensors and measuring devices using SLDs and similar broadband light sources.

Accordingly, there is a need for an improved broadband light source apparatus and method. Described herein are a phase noise-modulated broadband light source apparatus and method for delivering output light conditioned to have reduced RMS spectral modulation depth, increased central degree of nth-order temporal coherence

$${g}_{out}^{( n )} ( 0 ) > {g}_{source}^{( n )} ( 0 ) ,$$

whereby n is an integer greater than or equal to 2, or both.

An embodiment apparatus may include a broadband light source configured to provide broadband source light, at least one optical phase modulator, and at least one output light path that the at least one optical phase modulator modulates.

Embodiment methods described herein may include providing a broadband light source, providing an optical phase modulator, and optimizing the characteristics of the optical phase modulator based on the characteristics of the broadband light source.

In a particular embodiment, a broadband light source apparatus includes a broadband light source configured to provide unconditioned, broadband source light. The apparatus also includes at least one optical phase modulator. The at least one optical phase modulator is configured to receive the unconditioned broadband source light and to deliver conditioned broadband output light having reduced spectral modulation depth, increased central degree of second-order temporal coherence

$${g}_{out}^{( 2 )} ( 0 ) > {g}_{source}^{( 2 )} ( 0 ) ,$$

or both, relative to the unconditioned broadband source light.

The unconditioned, broadband source light may be characterized by a relatively high RMS spectral modulation depth, for example greater than 0.1 dB, a relatively low central degree of second-order temporal coherence

$${g}_{source}^{( 2 )} ( 0 ) ,$$

for example less than 2.0, or both.

The reduction of spectral modulation depth, the increase in the central degree of second-order temporal coherence, or both may be tunable by tuning the phase noise modulation applied by the optical phase modulator.

The apparatus may further include a driver circuit electrically coupled to the at least one optical phase modulator, the driver circuit configured to tune phase noise modulation applied by the at least one optical phase modulator to the broadband source light to reduce the spectral modulation depth, increase the central degree of nth-order temporal coherence, or both.

The at least one optical phase modulator may include an electro-optic phase modulator, for example a bulk electro-optic phase modulator, an integrated waveguide electro-optic phase modulator, or a fiber optic electro-optic phase modulator. Alternatively, the at least one optical phase modulator may include an acousto-optic phase modulator.

The apparatus may also include at least one output light path that the at least one optical phase modulator modulates. The at least one output light path may include at least one of a free space light path and a guided light path.

The broadband light source apparatus may include a pair of output light paths including first and second output light paths. The first and second output light paths share a spatially common splitting junction, are subsequently separated into a pair of spatially isolated arms including first and second spatially isolated arms, such that the first output light path follows a first spatially isolated arm and the second output light path follows a second spatially isolated arm, and are finally recombined to share a spatially common recombination junction. The at least one optical phase modulator may modulate either the first or second output light path, whereby the at least one optical phase modulator may occupy either the first or second spatially isolated arm.

The broadband light source apparatus may include a plurality of optical phase modulators. The plurality of optical phase modulators may include at least first and second optical phase modulators. The at least first and second optical phase modulators may be cascaded to both modulate the first or second output light path, whereby the first optical phase modulator occupies the first or second spatially isolated arm and the second optical phase modulator occupies either the spatially common splitting junction or the spatial common recombination junction.

Alternatively, the first optical phase modulator may modulate the first output light path and the second optical phase modulator may modulate the second output light path, whereby the first optical phase modulator occupies the first spatially isolated arm and the second optical phase modulator occupies the second spatially isolated arm. The plurality of optical phase modulators may further include at least a third optical phase modulator. The third optical phase modulator may be mutually cascaded with both the first and second optical phase modulators to modulate both the first and second output light paths, whereby the third optical phase modulator occupies either the spatially common splitting junction or the spatial common recombination junction.

The broadband light source may include a quartet of output light paths including first, second, third and fourth output light paths. In one example, the first, second, third, and fourth output light paths share a first spatially common splitting junction, are subsequently separated into a first pair of spatially isolated arms including first and second spatially isolated arms, such that the first and third output light paths follow the first spatially isolated arm and the second and fourth output light paths follow the second spatially isolated arm, are subsequently recombined to share a first spatially common recombination junction, then subsequently share a second spatially common splitting junction, are subsequently separated again into a second pair of spatially isolated arms including third and fourth spatially isolated arms, such that the first and second output light paths follow the third spatially isolated arm and the third and fourth output light paths follow the fourth spatially isolated arm, and are finally recombined to share a second spatially common recombination junction. A first optical phase modulator may modulate either the set of the first and third optical paths or the set of the second and fourth optical paths, and a second optical phase modulator may modulate either the set of the first and second optical paths or the set of the third and fourth optical paths, whereby the first optical phase modulator occupies either the first or second spatially isolated arm and the second optical phase modulator occupies either the third or fourth spatially isolated arm. Additional phase modulators may additionally modulate any of the optical paths by appropriate occupation of any of the spatially isolated arms and any of the spatially common splitting and recombination junctions.

The light source may include at least one of a superluminescent diode (SLD), a rare-earth-doped superluminescent source (REDSLS), a light emitting diode (LED), and a supercontinuum fiber.

A fiber-optic gyroscope (FOG) may include the broadband light source apparatus, and the FOG may also include a coil of optical fiber and an optical coupling configured to couple the conditioned broadband output light into the coil of optical fiber. The at least one optical phase modulator may be integral to the sense loop of the FOG.

A ghost imaging system may include the broadband light source apparatus, and the ghost imaging system may also include an optical splitter, an object arm including an object and a bucket detector, a reference arm including a spatially resolving detector, and a correlator.

An optical coherence tomography system may include the broadband light source apparatus, and the optical coherence tomography system may also include an optical interferometer apparatus configured to split the conditioned broadband output light into a reference beam directed to a reference reflector and a sample beam directed to a sample, and to combine a reflected beam from said reference reflector with a returning beam from said sample to form a combined optical signal, a two photon detector configured to detect said combined optical signal by two photon absorption and to provide a corresponding electrical signal, a frequency separation system configured to separate a low frequency component from said electrical signal, and a data processor configured to provide a topographic reconstruction of said sample based, at least in part, on said low frequency component.

In another embodiment, a method for conditioning broadband light includes providing unconditioned broadband source light. The method also includes receiving, by at least one optical phase modulator, the unconditioned broadband source light and delivering conditioned broadband output light by at least one of reducing spectral modulation depth and increasing central degree of nth-order temporal coherence, characterized by a phase noise modulation enhancement factor, where n is an integer greater than or equal to 2, relative to the broadband source light.

The method may further include providing at least one output light path that the optical phase modulator modulates.

Providing the unconditioned broadband source light can include providing at least one of an SLD, a REDSLS, an LED, and a supercontinuum fiber.

Providing the at least one optical phase modulator can include providing at least one of an electro-optic phase modulator and an acousto-optic phase modulator.

Providing the at least one output light path can include providing at least one of a free space light path and a guided light path.

The method may further include tuning the reduction in spectral modulation depth, the increase in central degree of nth-order temporal coherence, or both by tuning the phase noise modulation applied by the at least one optical phase modulator.

In still another embodiment, an apparatus for conditioning broadband light includes means for providing unconditioned broadband source light. The apparatus also includes means for receiving, the unconditioned broadband source light and delivering conditioned broadband output light by at least one of reducing spectral modulation depth and increasing central degree of nth-order temporal coherence, characterized by a phase noise modulation enhancement factor, where n is an integer greater than or equal to 2, relative to the broadband source light.

The apparatus may further include any of the features described herein in relation to other embodiments.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

For a fuller understanding of the nature and objects of the disclosed embodiments, reference should be made to the following detailed description, taken in connection with the accompanying drawings, in which:

FIG. 1 is a schematic diagram of an existing prior art broadband light source apparatus including a broadband light source;

FIG. 2 shows an exemplary output spectrum for the prior art broadband light source apparatus shown in FIG. 1;

FIG. 3 shows an exemplary plot of degree of second-order temporal coherence g⁽²⁾(τ) for different pump currents for the prior art broadband light source apparatus shown in FIG. 1;

FIG. 4A is a schematic diagram of a phase noise-modulated broadband light source apparatus for delivering conditioned output light including a single output light path modulated by an optical phase modulator in accordance to an embodiment of the present disclosure;

FIG. 4B is a schematic diagram of a driver circuit for controlling the phase noise modulation of the optical phase modulator;

FIGS. 5A, 5B, 5C and 5D are schematic diagrams of various phase noise-modulated broadband light source apparatuses, each including a pair of output light paths that are modulated by one, two, or three optical phase modulators in accordance to additional embodiments of the present disclosure;

FIG. 6 is a diagram showing the construction of the pair of output light paths shown in FIGS. 5A, 5B, 5C and 5D;

FIG. 7 is a plot of exemplary phase noise modulation enhancement factor as a function of phase noise standard deviation for various spectral widths;

FIG. 8 is a plot of exemplary central degree of second-order temporal coherence of the conditioned broadband output light as a function of phase noise standard deviation for various spectral widths for two different values of the central degree of second-order temporal coherence of the unconditioned broadband source light.

FIG. 9 is a plot of exemplary central degree of second-order temporal coherence for unconditioned broadband source light and conditioned broadband output light, as well as phase noise modulation enhancement factor and Gaussian phase noise standard deviation, as a function of pump current for an SLD.

FIG. 10 is a schematic diagram of a phase noise-modulated broadband light source apparatus including a quartet of output light paths modulated by two optical phase modulators in accordance to another embodiment of the present disclosure;

FIG. 11 is a diagram showing the construction of the quartet of output light paths shown in FIG. 10;

FIG. 12 shows an exemplary output spectrum for any one of the phase noise-modulated broadband light source apparatuses shown in FIGS. 4A, 5C and 5D;

FIG. 13 is a schematic diagram illustrating a fiber optic gyroscope (FOG) that incorporates any of the phase noise-modulated broadband light source apparatuses of FIGS. 4A, 5A-5D and FIG. 10;

FIG. 14 is a schematic diagram illustrating a ghost imaging system that incorporates any of the phase noise-modulated broadband light source apparatuses of FIGS. 4A, 5A-5D and FIG. 10; and

FIG. 15 is a schematic diagram illustrating a tomography system that incorporates any of the phase noise-modulated broadband light source apparatuses of FIGS. 4A, 5A-5D and FIG. 10.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION

A description of example embodiments of the invention follows. The following is a detailed description of the preferred embodiments of the invention, reference being made to the drawings in which the same reference numerals identify the same elements of structure in each of the several figures.

Figures shown and described herein are provided in order to illustrate key principles of operation and component relationships along their respective optical paths according to the present disclosure and are not drawn with intent to show actual size or scale. Some exaggeration may be necessary in order to emphasize basic structural relationships or principles of operations.

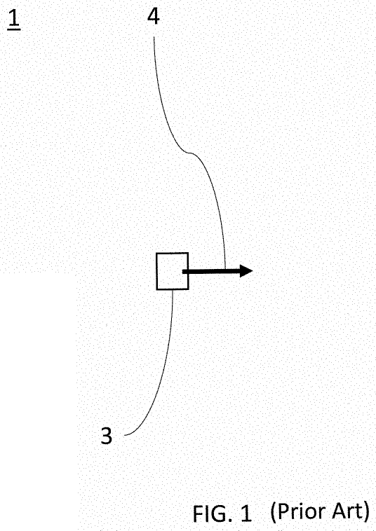

FIG. 1 is a schematic diagram of a prior art light source apparatus 1 including a broadband light source 3, such as an SLD, REDSLS, LED, or supercontinuum fiber, whose unconditioned output light 4 suffers from relatively high spectral modulation, also known as gain ripple, or has relatively low central degree of nth-order temporal coherence, or both.

As used herein, “broadband” source light denotes light with a spectrum having a full width at half maximum (FWHM) greater than or equal to 1 nm.

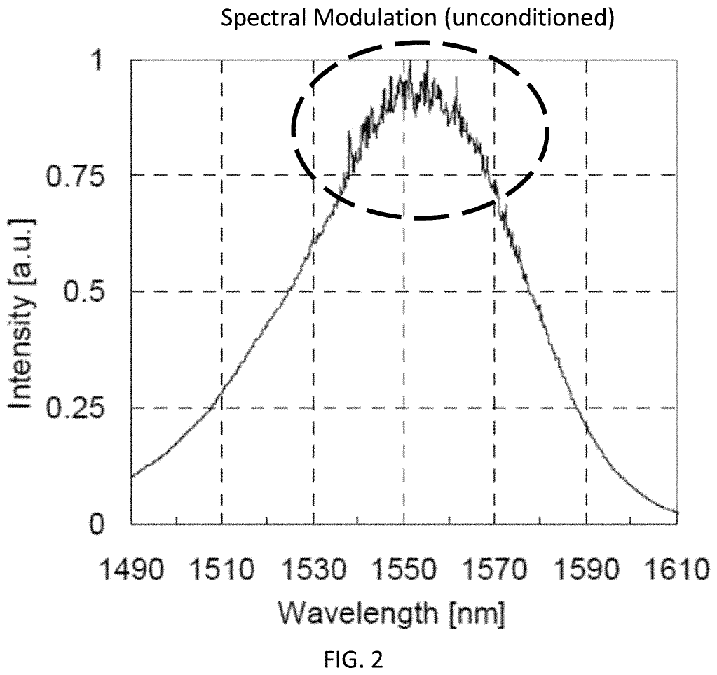

FIG. 2 shows an exemplary output spectrum for prior art broadband light source apparatus 1 shown in FIG. 1 wherein the RMS spectral modulation depth is a relatively high value of approximately 0.2 dB.

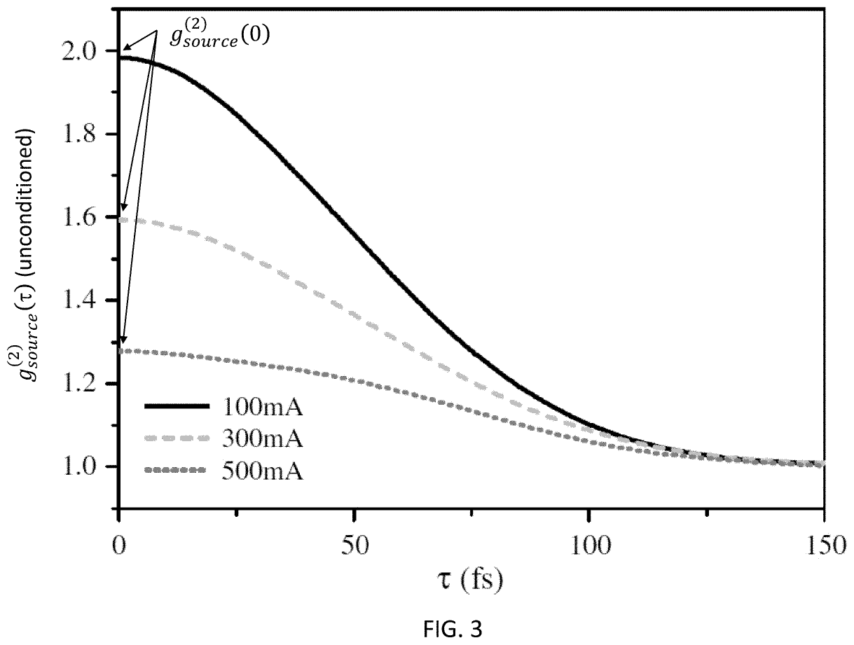

FIG. 3 shows an exemplary plot of the degree of second-order temporal coherence

$${g}_{source}^{( 2 )} ( τ )$$

for prior art broadband light source apparatus 1 shown in FIG. 1 for different pump currents. Although

$${g}_{source}^{( 2 )} ( 0 )$$

can be as high as a respectable value of 2 for relatively low pump currents below threshold, for example 100 mA, only spontaneous emission is present, and the output power is very low, only in the microwatt regime. At a current of 130 mA, amplified spontaneous emission sets in and the output power increases at a rate of 0.054 mW/mA, so at a current of 300 mA the output power is approximately 9.2 mW, but

$${g}_{source}^{( 2 )} ( 0 )$$

has decreased to approximately 1.6; at a current of 500 mA the output power is approximately 20 mW, but

$${g}_{source}^{( 2 )} ( 0 )$$

has decreased further to approximately 1.3.

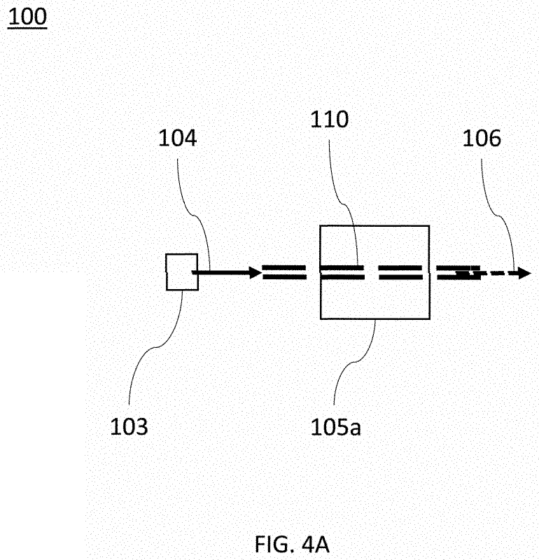

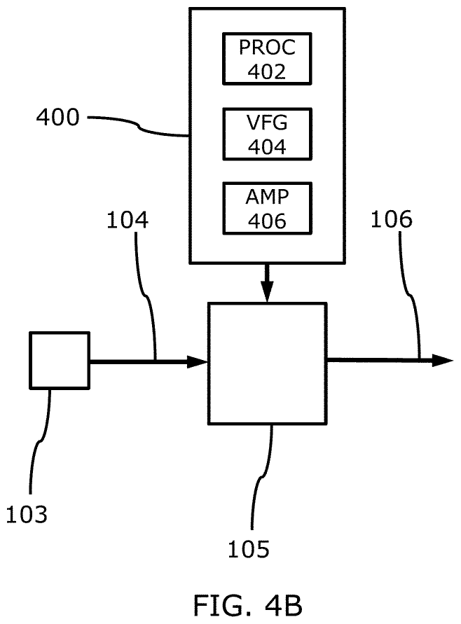

FIG. 4A is a schematic diagram illustrating an embodiment phase noise-modulated broadband light source apparatus 100 for delivering conditioned output light 106, the apparatus 100 including broadband light source 103, such as a superluminescent diode (SLD), rare-earth-doped superluminescent source (REDSLS), light emitting diode (LED), or supercontinuum fiber, whose unconditioned emission light 104 (also referred to herein as unconditioned broadband source light) is characterized by a relatively high RMS spectral modulation depth, for example greater than 0.1 dB, a relatively low central degree of second-order temporal coherence

$${g}_{source}^{( 2 )} ( 0 ) ,$$

for example less than 2.0, or both.

Apparatus 100 also includes at least one optical phase modulator 105a. Apparatus 100 also includes at least one output light path 110 that optical phase modulator 105a modulates. Optical phase modulator 105a is configured to receive unconditioned broadband source light 104 and to deliver conditioned broadband output light 106 that is conditioned to have reduced spectral modulation depth relative to unconditioned broadband source light 104 by means of spectral broadening of the spectral modulation features by, for example, Gaussian phase noise modulation.

By use of the optical phase modulator 105a, apparatus 100 may reduce spectral modulation depth from a value greater than 0.1 dB (in the unconditioned broadband light) to a value less than or equal to 0.1 dB, less than or equal to 0.05 dB, or less than or equal to 0.02 dB (in the conditioned light).

Optical phase modulator 105a may include an electro-optic phase modulator, for example a bulk electro-optic phase modulator, an integrated waveguide electro-optic phase modulator, or a fiber optic electro-optic phase modulator. Optical phase modulator 105a may include an acousto-optic phase modulator.

Output light path 110 may include at least one of a free space light path and a guided light path.

FIG. 4B is a schematic diagram of an example driver circuit 400 for controlling the phase noise modulation of the optical phase modulator 105. The driver circuit 400 includes a processor (PROC) 402, a versatile function generator (VFG) 404, and an amplifier (AMP) 406, and the driver circuit 400 is electrically coupled to the optical phase modulator 105.

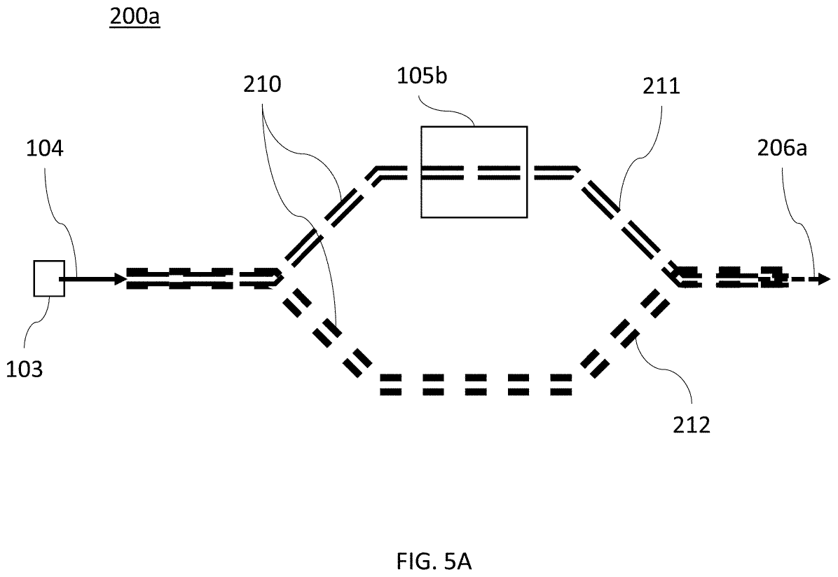

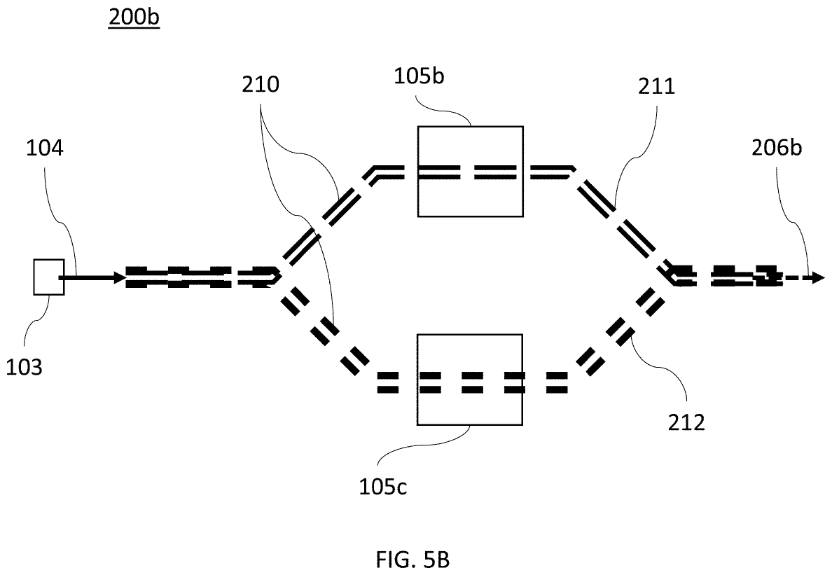

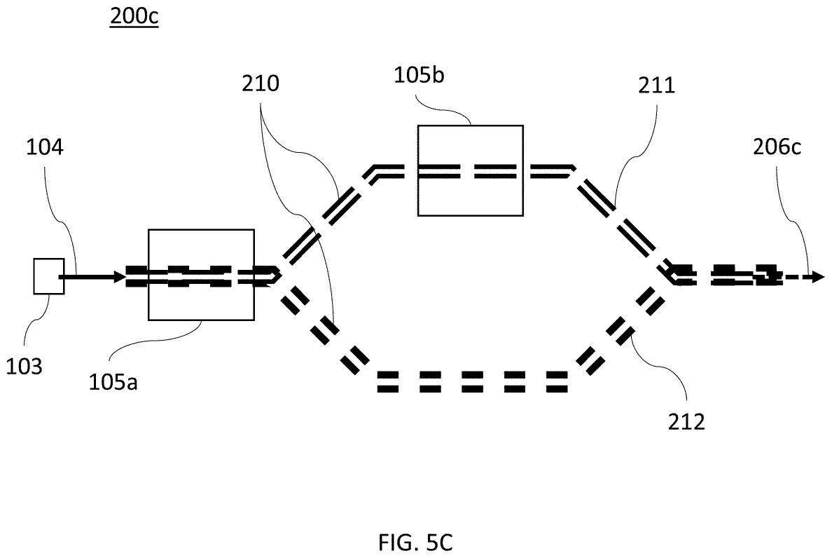

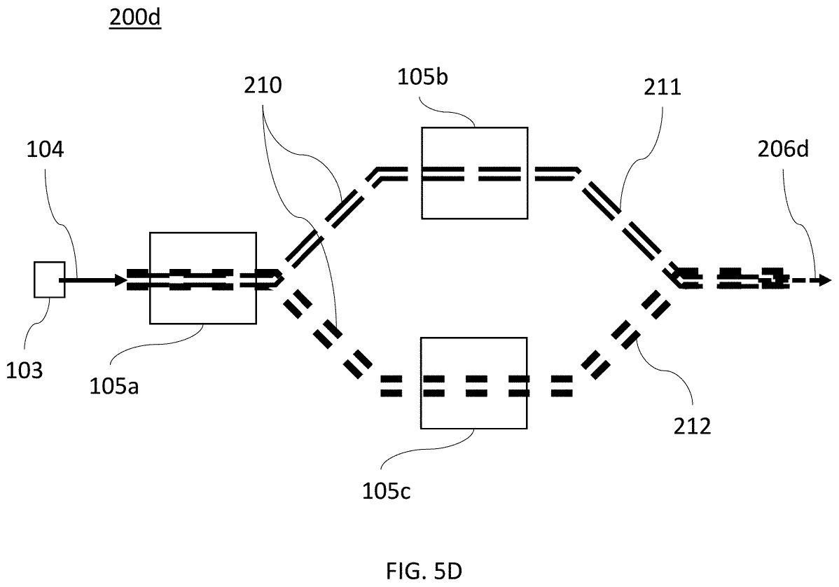

FIGS. 5A, 5B, 5C, and 5D are schematic diagrams illustrating phase noise-modulated broadband light source apparatuses 200a, 200b, 200c and 200d, respectively, for delivering conditioned output light 206a, 206b, 206c and 206d, respectively. Similar to apparatus 100 of FIG. 4A, apparatuses 200a, 200b, 200c and 200d also include broadband light source 103 with unconditioned emission light 104. However, instead of a single output light path, apparatuses 200a, 200b, 200c and 200d each include a pair 210 including first and second output light paths 211 and 212, respectively.

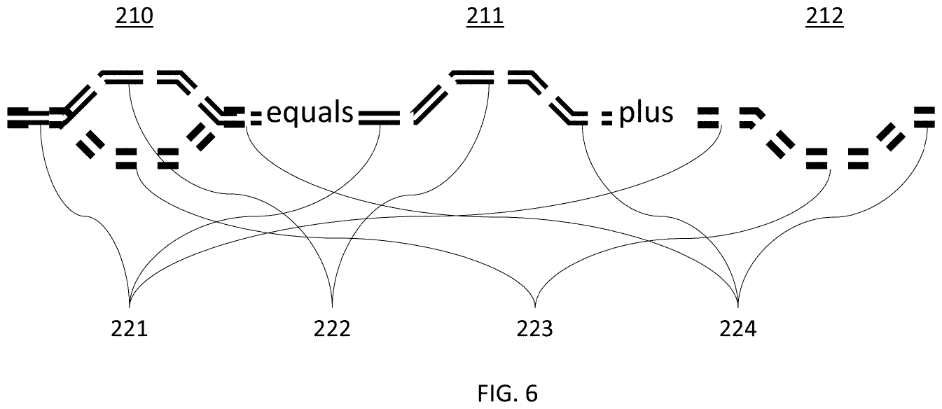

FIG. 6 is a diagram showing a construction of the pair 210 of output light paths from individual first and second output light paths 211 and 212 indicating that they share a spatially common splitting junction 221, are subsequently separated into a pair of spatially isolated arms including first and second spatially isolated arms 222 and 223, respectively, such that first output light path 211 follows first spatially isolated arm 222 and second output light path 212 follows second spatially isolated arm 223, and are finally recombined to share a spatially common recombination junction 224.

As shown in FIG. 5A, phase noise-modulated broadband light source apparatus 200a also includes at least one optical phase modulator 105b. Optical phase modulator 105b is configured to receive unconditioned broadband source light 104 in the first spatially isolated arm 222 and, after recombination at spatially common recombination junction 224, to deliver conditioned broadband output light 206a that is conditioned to have increased central degree of second-order temporal coherence

$${g}_{out}^{( 2 )} ( 0 ) > {g}_{source}^{( 2 )} ( 0 ) .$$

The increased

$${g}_{out}^{( 2 )} ( 0 )$$

resulting from phase noise modulation can be calculated as follows. Assuming unconditioned broadband source light 104 having a Gaussian spectrum, such as from SLDs, with first and second output light paths 211 and 212 approximated as equal and lossless, and with phase noise ϕ (t) as a function of time t introduced by optical phase modulator 105b into first output light path 211, the instantaneous intensity of conditioned broadband output light 206a averaged over a cycle of oscillation is given by

$${\overline{I}}_{out} ( t ) = \frac{1}{2} {\overline{I}}_{source} ( t ) \{ 1 + {e}^{- {\frac{π}{32} [ \frac{Δ λ φ ( t )}{{λ}_{0} ln ( 2 )} ]}^{2}} cos [ φ ( t ) ] \} ,$$

where Ī_{source} (t) is the intensity of the unconditioned broadband source light, λ₀ is the centroid wavelength, and Δλ is the spectral full width at half maximum (FWHM). The intensity of conditioned broadband output light 206a averaged over an observation period much longer than the coherence time is

$${〈 {\overline{I}}_{out} ( t ) 〉}_{t} = \frac{1}{2} {〈 {\overline{I}}_{source} ( t ) 〉}_{t} {〈 \{ 1 + {e}^{- {\frac{π}{32} [ \frac{Δ λ φ ( t )}{{λ}_{0} ln ( 2 )} ]}^{2}} cos [ φ ( t ) ] \} 〉}_{t} .$$

The central degree of second-order temporal coherence of the conditioned broadband output light 206a is given by

$${g}_{out}^{( 2 )} ( 0 ) = \frac{{〈 {{\overline{I}}_{out} ( t )}^{2} 〉}_{t}}{{〈 {\overline{I}}_{out} ( t ) 〉}_{t}^{2}} = \frac{{〈 {{\overline{I}}_{source} ( t )}^{2} 〉}_{t} \cdot {〈 {\{ 1 + {e}^{- {\frac{π}{32} [ \frac{Δ λ φ ( t )}{{λ}_{0} ln ( 2 )} ]}^{2}} cos [ φ ( t ) ] \}}^{2} 〉}_{t}}{{〈 {{\overline{I}}_{source} ( t )}^{2} 〉}_{t} \cdot {〈 \{ 1 + {e}^{- {\frac{π}{32} [ \frac{Δ λ φ ( t )}{{λ}_{0} ln ( 2 )} ]}^{2}} cos [ φ ( t ) ] \} 〉}_{t}^{2}} = {g}_{source}^{( 2 )} ( 0 ) \frac{{〈 {\{ 1 + {e}^{- {\frac{π}{32} [ \frac{Δ λ φ ( t )}{{λ}_{0} ln ( 2 )} ]}^{2}} cos [ φ ( t ) ] \}}^{2} 〉}_{t}}{{〈 \{ 1 + {e}^{- {\frac{π}{32} [ \frac{Δ λ φ ( t )}{{λ}_{0} ln ( 2 )} ]}^{2}} cos [ φ ( t ) ] \} 〉}_{t}^{2}} .$$

Defining the phase noise modulation enhancement factor (PNMEF) ζ as

$$ζ ≡ \frac{{〈 {\{ 1 + {e}^{- {\frac{π}{32} [ \frac{Δ λ φ ( t )}{{λ}_{0} ln ( 2 )} ]}^{2}} cos [ φ ( t ) ] \}}^{2} 〉}_{t}}{{〈 \{ 1 + {e}^{- {\frac{π}{32} [ \frac{Δ λ φ ( t )}{{λ}_{0} ln ( 2 )} ]}^{2}} cos [ φ ( t ) ] \} 〉}_{t}^{2}} ,$$

by invoking Cauchy's inequality,

$${〈 \{ 1 + {e}^{- {\frac{π}{32} [ \frac{Δ λ φ ( t )}{{λ}_{0} ln ( 2 )} ]}^{2}} cos [ φ ( t ) ] \} 〉}_{t}^{2} \leq {〈 {\{ 1 + {e}^{- {\frac{π}{32} [ \frac{Δ λ φ ( t )}{{λ}_{0} ln ( 2 )} ]}^{2}} cos [ φ ( t ) ] \}}^{2} 〉}_{t} ,$$

it becomes clear that ζ≥1, and hence

$${g}_{out}^{( 2 )} ( 0 ) = ζ {g}_{source}^{( 2 )} ( 0 ) \geq {g}_{source}^{( 2 )} ( 0 ) .$$

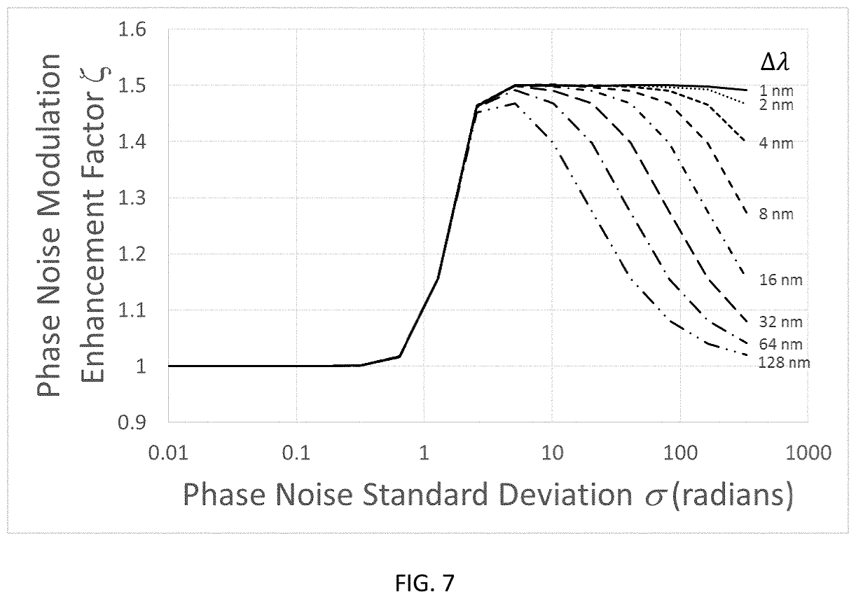

FIG. 7 is a plot of the phase noise modulation enhancement factor as a function of phase noise standard deviation for various spectral widths Δλ ranging from 1 nm to 128 nm, assuming unconditioned broadband source light 104 having a Gaussian spectrum with 1550 nm centroid wavelength. For all the various Δλ's, ζ≅1 for σ<0.3 rad, and ζ increases with increasing σ up to a maximum value of ζ≅1.5 by σ≅5 rad. However, ζ for the relatively larger (i.e., wider) Δλ's begins to decrease quickly with further increasing σ>5 rad, while ζ for the relatively smaller (i.e., narrower) Δλ's decreases more slowly with further increasing σ>5 rad.

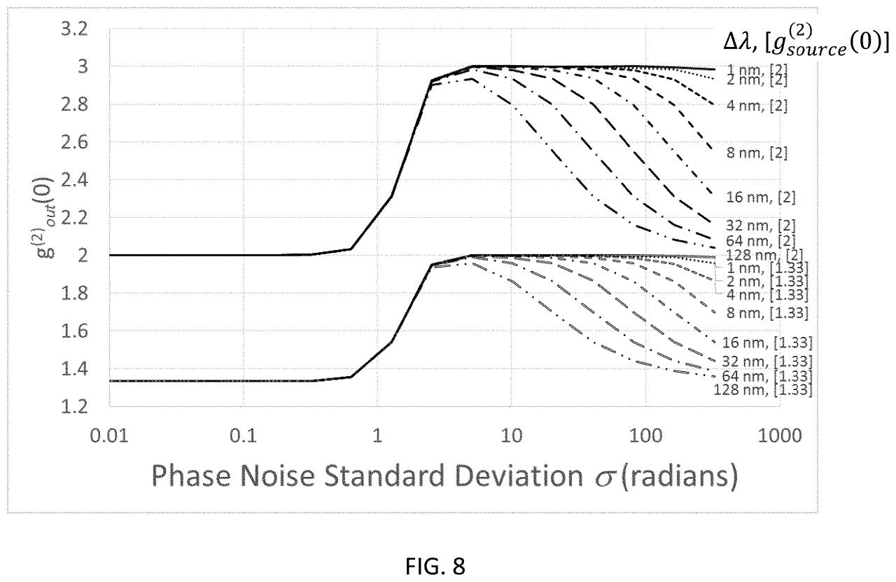

In FIG. 8, the upper set of curves show

$${g}_{out}^{( 2 )} ( 0 )$$

as a function of phase noise standard deviation for various spectral widths Δλ ranging from 1 nm to 128 nm, assuming purely chaotic, unconditioned broadband source light 104 having

$${g}_{source}^{( 2 )} ( 0 ) = 2$$

and a Gaussian spectrum with 1550 nm centroid wavelength. However, SLDs may have a much lower

$${g}_{source}^{( 2 )} ( 0 ) ,$$

especially at higher output powers. The lower set of curves in FIG. 8 show

$${g}_{out}^{( 2 )} ( 0 )$$

with the same parameters as the upper set but with

$${g}_{source}^{( 2 )} ( 0 ) = 1.33 .$$

It is interesting to note that when the phase noise modulation is tuned to have a standard deviation σ to maximize ζ to 1.5, for

$${g}_{source}^{( 2 )} ( 0 ) = 1.33$$

the resulting

$${g}_{out}^{( 2 )} ( 0 ) = 1.5 \times 1.33 = 2 ,$$

which can be an optimal value for certain applications such as FOGs.

If

$$1.33 < {g}_{source}^{( 2 )} ( 0 ) < 2 ,$$

then the phase noise standard deviation a could be detuned to reduce ζ in order to maintain

$${g}_{out}^{( 2 )} ( 0 ) = 2.$$

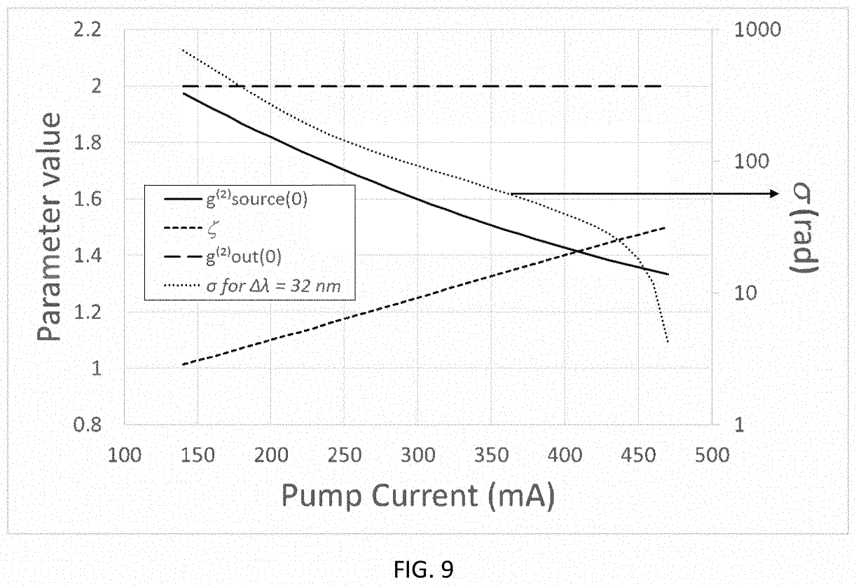

FIG. 9 is a graph showing a plot of the various parameter values including

$${g}_{source}^{( 2 )} ( 0 )$$

(plotted against primary axis at left), ranging from 2 at low pump current to 1.33 at high pump current, for an exemplary SLD. FIG. 9 also shows the phase noise modulation enhancement factor ζ (plotted against primary axis at left) that is required to achieve

$${g}_{out}^{( 2 )} ( 0 ) = 2$$

(also plotted as a horizontal line for reference against primary axis at left). Furthermore, FIG. 9 shows the required Gaussian phase noise standard deviation σ (plotted against secondary axis at right) in order to detune ζ as a function of pump current, assuming Δλ=32 nm.

In FIG. 5B, phase noise-modulated broadband light source apparatus 200b includes the same elements as apparatus 200a in FIG. 5A, but also includes a second optical phase modulator 105c. First and second optical phase modulators 105b and 105c are configured to receive unconditioned broadband source light 104 in the first and second spatially isolated arms 222 and 223, respectively, and, after recombination at spatially common recombination junction 224, to deliver conditioned broadband output light 206b that is conditioned to have increased central degree of second-order temporal coherence

$${g}_{out}^{( 2 )} ( 0 ) > {g}_{source}^{( 2 )} ( 0 ) .$$

In certain configurations, for example electro-optic integrated waveguide modulators, an advantage of using two optical phase modulators in parallel is that they can work in a push-pull geometry more efficiently to reduce the required voltage necessary to achieve a particular phase noise standard deviation.

In FIG. 5C, phase noise-modulated broadband light source apparatus 200c includes the same elements as apparatus 200a in FIG. 5A, but also includes a second optical phase modulator 105a. First and second optical phase modulators 105b and 105a are configured to receive unconditioned broadband source light 104 in the first spatially isolated arm 222 and in the spatially common splitting junction 221, respectively, and, after recombination at spatially common recombination junction 224, to deliver conditioned broadband output light 206c that is conditioned to have both reduced spectral modulation depth, as effected by second optical phase modulator 105a, and increased central degree of second-order temporal coherence

$${g}_{out}^{( 2 )} ( 0 ) > {g}_{source}^{( 2 )} ( 0 ) ,$$

as effected by first optical phase modulator 105b. An alternative location for second optical phase modulator 105a is in the spatially common recombination junction 224.

In FIG. 5D, phase noise-modulated broadband light source apparatus 200d includes the same elements as apparatus 200c in FIG. 5C, but also includes a third optical phase modulator 105c. First, second, and third optical phase modulators 105b, 105a 105c are configured to receive unconditioned broadband source light 104 in the first spatially isolated arm 222, in the spatially common splitting junction 221, and in the second spatially isolated arm 223, respectively, and, after recombination at spatially common recombination junction 224, to deliver conditioned broadband output light 206d that is conditioned to have both reduced spectral modulation depth, as effected by second optical phase modulator 105a, and increased central degree of second-order temporal coherence

$${g}_{out}^{( 2 )} ( 0 ) > {g}_{source}^{( 2 )} ( 0 ) ,$$

as effected by first and third optical phase modulators 105b and 105c. An alternative location for second optical phase modulator 105a is in the spatially common recombination junction 224.

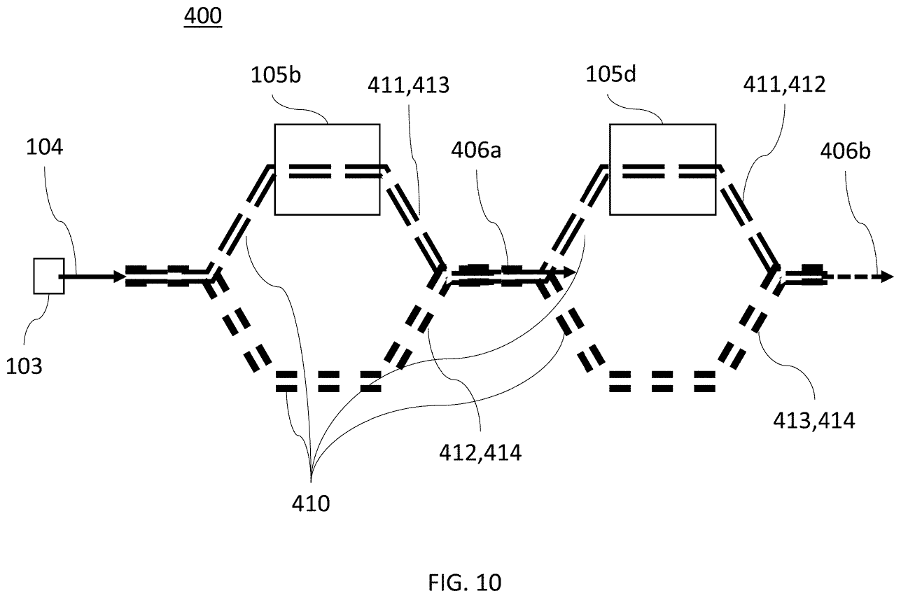

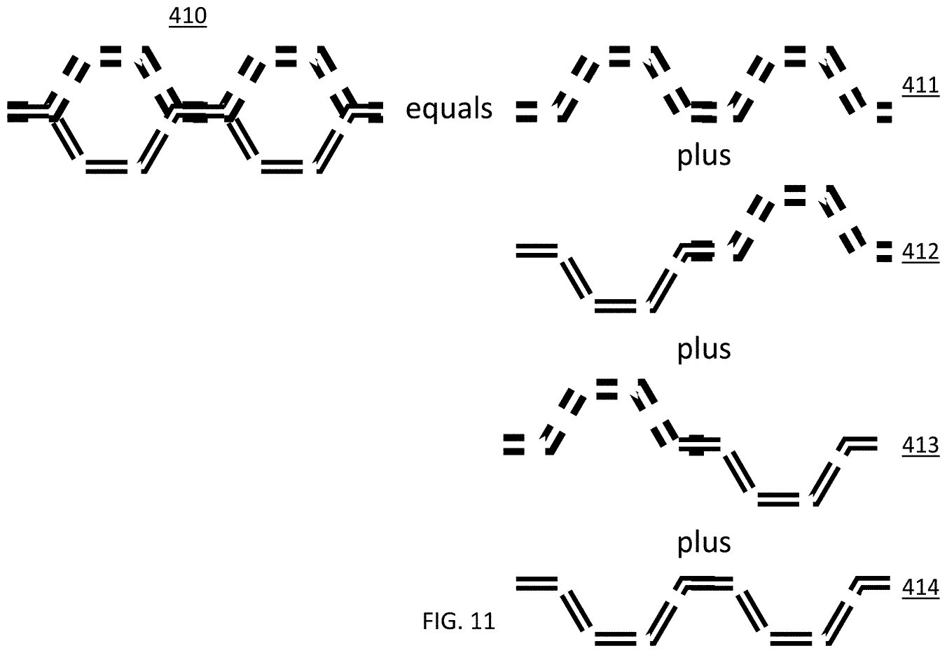

FIG. 10 shows a schematic of phase noise-modulated broadband light source apparatus 400 for delivering conditioned output light 406. Similar to apparatus 200a, apparatus 400 also includes broadband light source 103 with unconditioned emission light 104. However, instead of pair 210, apparatus 400 includes a quartet 410 including first, second, third and fourth output light paths 411, 412, 413 and 414, respectively. FIG. 11 is a diagram showing a construction of the quartet 410 of output light paths from individual first, second, third and fourth output light paths 411, 412, 413 and 414 indicating that they share a first spatially common splitting junction, are subsequently separated into a first pair of spatially isolated arms including first and second spatially isolated arms, such that first and third output light paths 411 and 413 follow the first spatially isolated arm and second and fourth output light paths 412 and 414 follow the second spatially isolated arm, are subsequently recombined to share a first spatially common recombination junction, are subsequently split again by a shared second spatially common splitting junction, are subsequently separated again into a second pair of spatially isolated arms including third and fourth spatially isolated arms, such that first and second output light paths 411 and 412 follow the first spatially isolated arm and third and fourth output light paths 413 and 414 follow the second spatially isolated arm, and are finally recombined to share a spatially common recombination junction.

As shown in FIG. 10, phase noise-modulated broadband light source apparatus 400 also includes first and second optical phase modulators 105b and 105d. First optical phase modulator 105b may modulate either the set of the first and third optical paths 411 and 413, as shown, or alternatively the set of second and fourth optical paths 412 and 414, and second optical phase modulator 105d may modulate either the set of first and second optical paths 411 and 412, as shown, or alternatively the set of third and fourth optical paths 413 and 414, whereby first optical phase modulator 105b occupies either the first or second spatially isolated arm and second optical phase modulator 105d occupies either the third or fourth spatially isolated arm. Additional phase modulators may additionally modulate any of the optical paths by appropriate occupation of any of the spatially isolated arms and any of the spatially common splitting and recombination junctions. First optical phase modulator 105b is configured to receive unconditioned broadband source light 104 and to deliver partially conditioned broadband intermediate light 406a that is partially conditioned to have partially increased central degree of second-order temporal coherence

$${g}_{intermediate}^{( 2 )} ( 0 ) > {g}_{source}^{( 2 )} ( 0 ) .$$

Second optical phase modulator 105d is configured to receive partially conditioned broadband intermediate light 406a and to deliver conditioned broadband output light 406b that is further conditioned to have further increased central degree of second-order temporal coherence

$${g}_{out}^{( 2 )} ( 0 ) > {g}_{intermediate}^{( 2 )} ( 0 ) .$$

Each individual stage i of phase modulation can be tuned to effect an individual phase noise modulation enhancement factor ζᵢ of up to 1.5, and the total effective phase noise modulation enhancement factor is given by ζ=Πζᵢ, for example 1.5×1.5=2.25.

Beyond increasing just the central degree of second-order temporal coherence

$${g}_{out}^{( 2 )} ( 0 ) ,$$

the phase noise-modulated broadband light source apparatus of the present disclosure may be generalized to increase the central degree of nth-order temporal coherence

$${g}_{out}^{( n )} ( 0 ) ,$$

whereby n is an integer greater than or equal to 2.

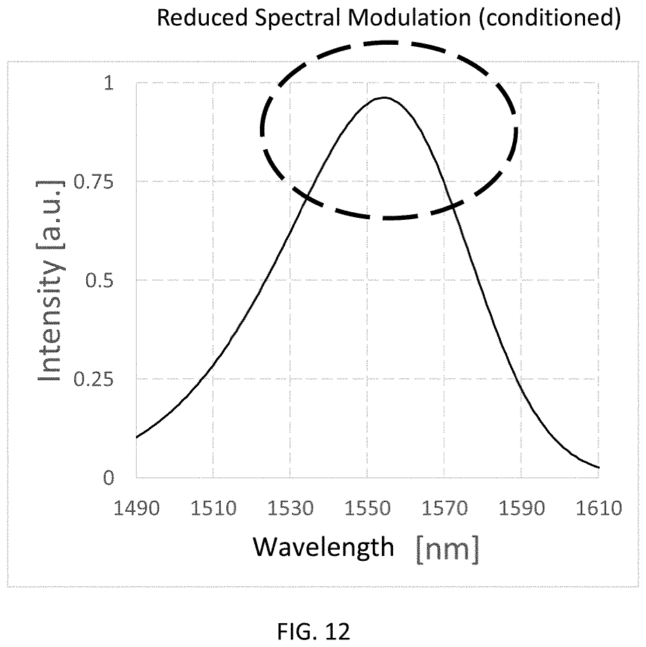

FIG. 12 shows an exemplary output spectrum for any one of the phase noise-modulated broadband light source apparatuses shown in FIG. 4, 5C or 5D, showing the reduced spectral modulation depth effected by the phase noise modulation of at least one output light path that may be in at least one spatially common splitting or recombination junction. Some reduction of spectral modulation depth may also be effected by phase noise modulation of at least one output light path in at least one spatially isolated arm.

For the function of reducing spectral modulation depth, it should be understood that the presence of divided paths is not required (as shown in FIG. 4A). However, for embodiments that include divided paths, for the function of reducing spectral modulation depth, location at either splitter and/or recombiner are preferred embodiments because the division of the paths does not particularly come into play (i.e., there is no particular motivation for locating the phase modulator in the divided paths for the sole purpose of reducing spectral modulation depth). This is not to say that the function of reducing spectral modulation depth cannot be achieved with the phase modulator located in the divided paths. On the other hand, the function of increasing central degree of nth-order temporal coherence requires divided paths and cannot be achieved by locating the phase modulator at the splitter or recombiner.

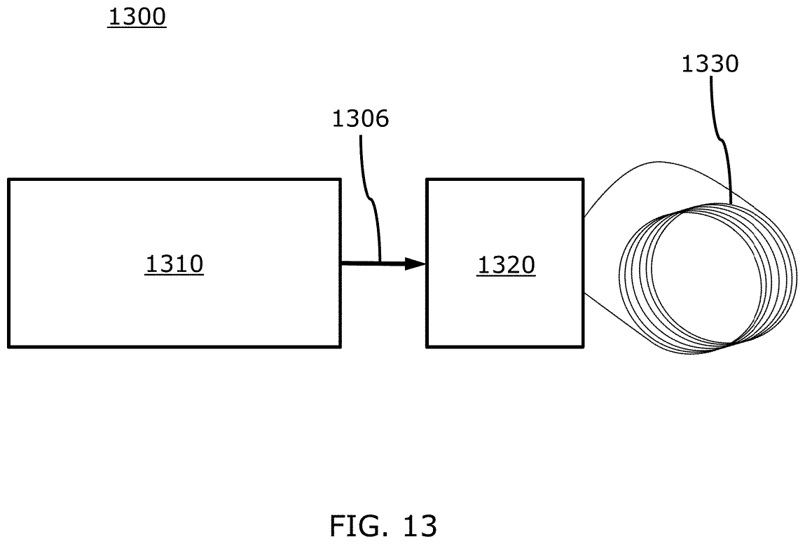

FIG. 13 illustrates an embodiment of a fiber optic gyroscope (FOG) 1300. The FOG 1300 incorporates broadband light source apparatus 1310 corresponding to any of broadband light source apparatuses 100, 200a, 200b, 200c, 200d or 400 (FIGS. 4A, 5A-5D and FIG. 10, respectively). The FOG 1300 includes a coupler 1320 that is configured to couple the broadband output light from the broadband light source apparatus 1310 into a coil 1330 of the FOG, which is used to form a Sagnac interferometer to sense rotation with high precision. The at least one optical phase modulator of the broadband light source apparatus 1310 may be integral to the sense loop of the FOG.

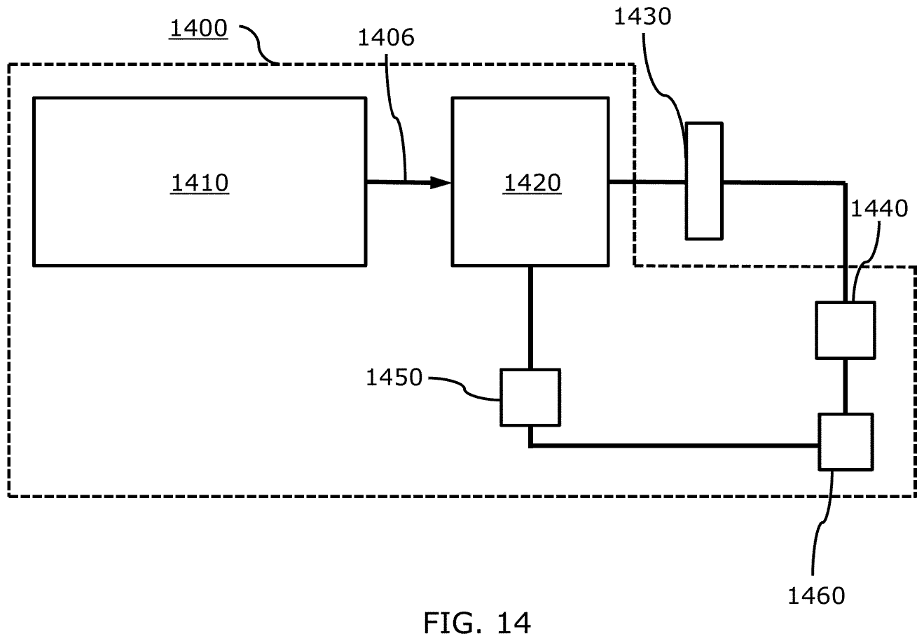

FIG. 14 illustrates an embodiment of a ghost imaging system 1400 for imaging an object 1430. The ghost imaging system 1400 incorporates broadband light source apparatus 1410 corresponding to any of broadband light source apparatuses 100, 200a, 200b, 200c, 200d or 400 (FIGS. 4A, 5A-5D and FIG. 10, respectively). The ghost imaging system 1400 may also include an optical splitter 1420, an object arm including a bucket detector 1440, a reference arm including a spatially resolving detector 1450, and a correlator 1460.

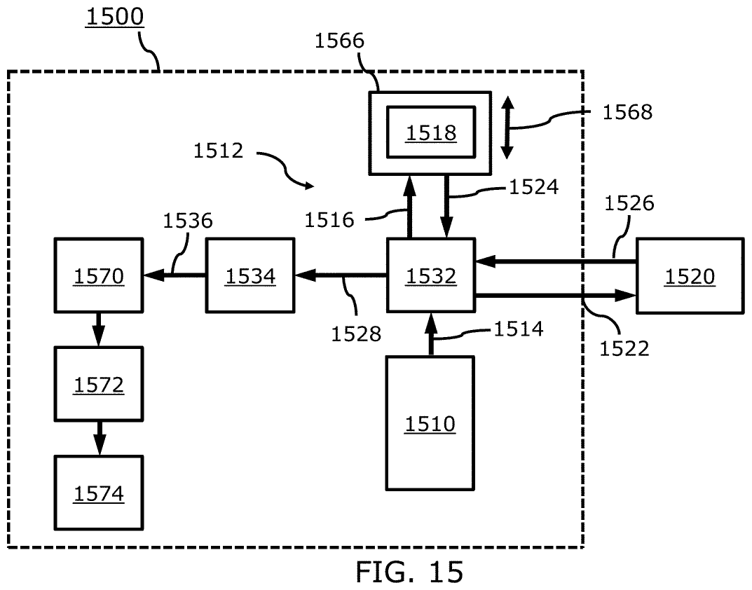

FIG. 15 illustrates an example system 1500 for optical coherence tomography (OCT) of a sample 1520, according to some embodiments of the present disclosure.

Sample 1520 can be a biological sample, for example, a lung, bronchus, intestine, esophagus, stomach, colon, eye, heart, blood vessel, cervix, bladder, urethra, skin, muscle, liver, kidney and blood vessel. Sample 1520 can also be a non-biological sample, for example, a non-biological object, such as a semiconductor wafer or device, an optical element, an electronic chip, an integrated circuit, a memory device, or any other industrial object.

System 1500 includes an optical interferometer apparatus 1512 which splits an optical beam 1514 into a reference optical beam 1516 directed to a reference reflector 1518 and a sample optical beam 1522 directed to sample 1520. Apparatus 1512 combines a reflected beam 1524 from reference reflector 1518 with a returning beam 1526 from sample 1520 to form a combined optical signal 1528.

Apparatus 1512 includes a light source 1510 for generating beam 1514 and a beam splitter 1532 which is configured to receive beam 1514 and to split it into beams 1516 and 1522, and to receive beams 1524 and 1526 and to combine them into an optical beam representing the interference between beams 1524 and 1526, referred to herein as combined optical signal 1528.

The light source 1510 may include any of broadband light source apparatuses 100, 200a, 200b, 200c, 200d or 400 (FIGS. 4A, 5A-5D and FIG. 10, respectively).

Reflector 1518 is mounted on a translation stage 1566 configured to establish a translation motion to reflector 1518 in the direction of beam splitter 1532 and in the opposite direction, as indicated by double arrow 1568. Such motion effects a change in the optical path difference within apparatus 1512 as known in the art. Stage 1566 is particularly useful for to providing time domain OCT, wherein the repositioning of reference reflector 1518 with respect to beam splitter 1532 allows system 1500 to perform depth scan.

System 1500 further includes a two-photon detector 1534 configured to detect optical signal 1528 by two photon absorption and to provide an electrical signal 1536. Generally, a two-photon detector 1534 includes a photocathode characterized by an energy gap selected such that a simultaneous absorption of two photons excites an electron-hole pair, which in turn provides a signal.

The electrical signal 1536 is digitized, e.g., by a digitizer 1570 such as an Analog-to-Digital converter (ADC). The separation of low frequency component can be performed digitally, e.g., by a digital frequency separation system generally shown at 1572. System 1572 is typically a low pass digital filter, which can be embodied as a separate unit, as shown in FIG. 15, or as a low pass digital filter software module accessible by a data processing apparatus 1574. Data processing apparatus 1574 can be embodied as a general-purpose computer or dedicated circuitry and may be configured to provide a topographic reconstruction of sample 1520 based on the separated low frequency component. The topographic reconstruction can be done using any computerized tomography (CT) procedure known in the art, including both time domain topographic reconstruction and frequency domain topographic reconstruction.

Additional techniques for OCT are generally disclosed in U.S. Patent Publication No. 2015/0168126.

As described hereinabove, an embodiment method for conditioning broadband light includes providing a broadband light source, at least one optical phase modulator, and at least one output light path that the optical phase modulator modulates. The method also includes configuring the optical phase modulator to receive unconditioned broadband source light from the broadband light source and to deliver conditioned broadband output light having reduced spectral modulation depth, increased central degree of nth-order temporal coherence, or both.

Providing the broadband source light can include providing at least one of an SLD, a REDSLS, an LED, and a supercontinuum fiber.

Providing the optical phase modulator can include providing at least one of an electro-optic phase modulator and an acousto-optic phase modulator.

Providing the output light path can include providing at least one of a free space light path and a guided light path.

The present disclosure has been described in detail with particular reference to certain preferred embodiments thereof, but it will be understood that variations and modifications can be effected within the scope of the present disclosure as described above by a person of ordinary skill in the art without departing from the scope of the present disclosure.

The teachings of all patents, published applications and references cited herein are incorporated by reference in their entirety.

What is claimed is:

1. An apparatus comprising:
a broadband light source configured to provide broadband source light; and
at least one optical phase modulator configured to receive the broadband source light and to deliver conditioned broadband output light having at least one of reduced spectral modulation depth and increased central degree of nth-order temporal coherence, characterized by a phase noise modulation enhancement factor, where n is an integer greater than or equal to 2, relative to the broadband source light.

2. The apparatus of claim 1, further comprising a driver circuit electrically coupled to the at least one optical phase modulator, the driver circuit configured to tune phase noise modulation applied by the at least one optical phase modulator to the broadband source light to reduce the spectral modulation depth, increase the central degree of nth-order temporal coherence, or both.

3. The apparatus of claim 2, wherein the phase noise modulation is Gaussian phase noise modulation.

4. The apparatus of claim 2, wherein the spectral modulation depth is reduced from a value greater than 0.1 dB to a value less than or equal to 0.1 dB.

5. The apparatus of claim 4, wherein the spectral modulation depth is reduced to a value less than or equal to 0.05 dB.

6. The apparatus of claim 5, wherein the spectral modulation depth is reduced to a value less than or equal to 0.02 dB.

7. The apparatus of claim 2, wherein the driver circuit is configured to tune the phase noise modulation to have a desired phase noise modulation enhancement factor.

8. The apparatus of claim 7, wherein the phase noise modulation enhancement factor is greater than or equal to 1.1.

9. The apparatus of claim 8, wherein the phase noise modulation enhancement factor is greater than or equal to 1.3.

10. The apparatus of claim 9, wherein the phase noise modulation enhancement factor is greater than or equal to 1.5.

11. The apparatus of claim 10, wherein the phase noise modulation enhancement factor is greater than or equal to 2.25.

12. The apparatus of claim 1, wherein the at least one optical phase modulator is further configured to deliver the conditioned broadband output light along a free space light path or a guided light path.

13. The apparatus of claim 1, further comprising an optical splitting junction, an optical recombination junction, a first output light path, and a second output light path, wherein the optical splitting junction is configured to separate the first and second output light paths into a pair of arms comprising a first arm and a second arm, such that the first output light path follows the first arm and the second output light path follows the second arm, and the optical recombination junction is configured to recombine the first and second output light paths, wherein the at least one optical phase modulator is configured to modulate the first or second output light path to provide the conditioned broadband output light having increased central degree of nth-order temporal coherence, relative to the broadband source light.

14. The apparatus of claim 1, further comprising an optical splitting junction, an optical recombination junction, a first output light path, and a second output light path, wherein the at least one optical phase modulator comprises a first optical phase modulator and a second optical phase modulator, wherein the optical splitting junction is configured to separate the first and second output light paths into a pair of arms comprising a first arm and a second arm, such that the first output light path follows the first arm and the second output light path follows the second arm, and the optical recombination junction is configured to recombine the first and second output light paths, wherein the first optical phase modulator is configured to modulate the first or second output light path to provide the conditioned broadband output light having increased central degree of nth-order temporal coherence, relative to the broadband source light, and the second optical phase modulator is configured to modulate the first and second output light paths to provide the conditioned broadband output light having reduced spectral modulation depth, relative to the broadband source light.

15. The apparatus of claim 1, further comprising an optical splitting junction, an optical recombination junction, a first output light path, and a second output light path, wherein the at least one optical phase modulator comprises a first optical phase modulator and a second optical phase modulator, wherein the optical splitting junction is configured to separate the first and second output light paths into a pair of arms comprising a first arm and a second arm, such that the first output light path follows the first arm and the second output light path follows the second arm, and the optical recombination junction is configured to recombine the first and second output light paths, wherein the first optical phase modulator is configured to modulate the first output light path, and the second optical phase modulator is configured to modulate the second output light path, the first and second optical phase modulators providing the conditioned broadband output light having increased central degree of nth-order temporal coherence, relative to the broadband source light.

16. The apparatus of claim 15, wherein the at least one optical phase modulator further comprises a third optical phase modulator configured to modulate the first and second output light paths to provide the conditioned broadband output light having reduced spectral modulation depth relative to the broadband source light.

17. The apparatus of claim 1, further comprising a first optical splitting junction, a second optical splitting junction, a first optical recombination junction, a second optical recombination junction, a first output light path, a second output light path, a third output light path, and a fourth output light path, wherein the at least one optical phase modulator comprises a first optical phase modulator and a second optical phase modulator, wherein the first optical splitting junction is configured to separate the output light paths into a first pair of arms comprising a first arm and a second arm, such that the first and third output light paths follow the first arm and the second and fourth output light paths follow the second arm, and the first optical recombination junction is configured to recombine the output light paths, wherein the second optical splitting junction is configured to separate the output light paths into a second pair of arms comprising a third arm and a fourth arm, such that the first and second output light paths follow the third arm and the third and fourth output light paths follow the fourth isolated arm, and the second optical recombination junction is configured to recombine the output light paths from the second pair of arms, wherein the first optical phase modulator is configured to modulate the first and third output light paths or the second and fourth output light paths, the second optical phase modulator is configured to modulate the first and second output light paths or the third and fourth output light paths, the first and second optical phase modulators providing the conditioned broadband output light having increased central degree of nth-order temporal coherence, relative to the broadband source light.

18. The apparatus of claim 1, wherein the at least one optical phase modulator comprises any of a bulk electro-optic phase modulator, an integrated waveguide electro-optic phase modulator, and a fiber optic electro-optic phase modulator.

19. The apparatus of claim 1, wherein the at least one optical phase modulator comprises an acousto-optic phase modulator.

20. The apparatus of claim 1, wherein the broadband light source comprises at least one of a superluminescent diode (SLD), a rare-earth-doped superluminescent source (REDSLS), a light emitting diode (LED), and a supercontinuum fiber.

21. A fiber-optic gyroscope (FOG) including the apparatus of claim 1, the FOG further including a coil of optical fiber and an optical coupling configured to couple the conditioned broadband output light into the coil of optical fiber.

22. A ghost-imaging system including the apparatus of claim 1, the ghost-imaging system further including an optical splitter, an object arm comprising an object and a bucket detector, a reference arm comprising a spatially resolving detector, and a correlator.

23. An optical coherence tomography system including the apparatus of claim 1, the optical coherence tomography system further including an optical interferometer apparatus configured to split the conditioned broadband output light into a reference beam directed to a reference reflector and a sample beam directed to a sample, and to combine a reflected beam from said reference reflector with a returning beam from said sample to form a combined optical signal, a two-photon detector configured to detect said combined optical signal by two-photon absorption and to provide a corresponding electrical signal, a frequency separation system configured to separate a low frequency component from said electrical signal, and a data processor configured to provide a topographic reconstruction of said sample based, at least in part, on said low frequency component.

24. A method comprising:
providing broadband source light; and
receiving, by at least one optical phase modulator, the broadband source light and delivering conditioned broadband output light by at least one of reducing spectral modulation depth and increasing central degree of nth-order temporal coherence, characterized by a phase noise modulation enhancement factor, where n is an integer greater than or equal to 2, relative to the broadband source light.

25. The method of claim 24, further comprising driving the at least one optical phase modulator, by a driver circuit, to tune phase noise modulation applied by the at least one optical phase modulator to the broadband source light to reduce the spectral modulation depth, increase the central degree of nth-order temporal coherence, or both.

26. The method of claim 25, wherein the phase noise modulation is Gaussian phase noise modulation.

27. The method of claim 25, wherein the spectral modulation depth is reduced from a value greater than 0.1 dB to a value less than or equal to 0.1 dB.

28. The method of claim 27, wherein the spectral modulation depth is reduced to a value less than or equal to 0.05 dB.

29. The method of claim 28, wherein the spectral modulation depth is reduced to a value less than or equal to 0.02 dB.

30. The method of claim 25, wherein the phase noise modulation is tuned to have a desired phase noise modulation enhancement factor.

31. The method of claim 30, wherein the phase noise modulation enhancement factor is greater than or equal to 1.1.

32. The method of claim 31, wherein the phase noise modulation enhancement factor is greater than or equal to 1.3.

33. The method of claim 32, wherein the phase noise modulation enhancement factor is greater than or equal to 1.5.

34. The method of claim 33, wherein the phase noise modulation enhancement factor is greater than or equal to 2.25.

35. The method of claim 24, wherein the conditioned broadband output light is delivered along a free space light path or a guided light path.

36. An apparatus comprising:
means for providing broadband source light; and
means for receiving the broadband source light and delivering conditioned broadband output light by at least one of reducing spectral modulation depth and increasing central degree of nth-order temporal coherence, characterized by a phase noise modulation enhancement factor, where n is an integer greater than or equal to 2, relative to the broadband source light.
